(19) United States
(12) Patent Application Publication
(10) Pub. No.: US 2020/0160721 A1
(43) Pub. Date: May 21, 2020

(54) SYSTEMS AND METHODS FOR MANAGING TRACTOR TRAILERS

(71) Applicant: Peloton Technology, Inc., Mountain View, CA (US)

(72) Inventors: Joshua P. Switkes, Mountain View, CA (US); Igor Prilepov, Palo Alto, CA (US); Daniel Jones, Santa Clara, CA (US); Mark Luckevich, San Jose, CA (US)

(73) Assignee: Peloton Technology, Inc., Mountain View, CA (US)

(21) Appl. No.: 16/175,674

(22) Filed: Nov. 21, 2018

(51) Int. Cl. G08G 1/00; G05D 1/02; G08G 1/16; B60W 30/165

(52) U.S. Cl. CPC G08G 1/22; G05D 1/0293; B60W 10/20; B60W 30/165; G08G 1/163

(57) ABSTRACT

Systems and methods for increasing the safety of vehicle platooning systems are described. In one aspect, a determination is made as to how many trailers are connected to a tractor, and whether those trailers and any dollies are equipped with an Anti-Lock Braking System. For example, an average rate of messages that indicate an ABS system is operating correctly may be determined. Also, an amount of messages received within a certain time interval may be determined. Based on whether the average rate is above a threshold amount and whether an amount of messages were received within one or more time intervals a determination may be made as to whether an adverse action occurs such as losing the authority to cause a trailer to brake fully and/or dissolve a platoon.

### BACKGROUND

Enabling a vehicle to follow closely behind one vehicle safely through partial or full automation has significant fuel savings, safety, and/or labor savings benefits, but is generally unsafe when a driver tries to do this manually. Presently, during normal driving, vehicle motion is controlled either manually, by a driver, or by convenience systems, such as cruise control or adaptive cruise control. The various types of cruise control systems control vehicle speed to make driving more pleasurable or relaxing, by partially automating the driving task. Some of these systems use range sensors and/or vehicle sensors to control the speed to maintain a constant headway relative to the leading vehicle (also referred to herein as a front vehicle). In general, these cruise control systems provide minimal added safety, and do not have full control of the vehicle (in terms of being able to fully brake or accelerate).

Driver control does not match the safety performance of even current systems, for several reasons. First, a driver cannot safely maintain a close following distance. In fact, the relatively short distances between vehicles necessary to get any measurable fuel savings results in an unsafe condition if the vehicle is under driver control, thereby risking a costly and destructive accident. Further, the driver is not as capable of maintaining an optimal headway as an automated system is. In fact, a driver trying to maintain a constant headway often causes rapid and large changes in command (accelerator pedal position for example), resulting in a loss of efficiency.

Thus, it would be desirable to have reliable and economical semi-automated vehicular convoying/platooning systems which enable vehicles to follow closely together in a safe, efficient, convenient manner.

### SUMMARY

The systems and methods comprising various aspects of the disclosure described herein provide for increased platooning safety.

For example, without limitation, aspects of the present invention enable methods for determining a rate of messages received at a brake electronic control unit (BECU) from an Anti-Lock Braking System (ABS) unit via a Power Line Communication (PLC). Further, an amount of messages received during one or more time intervals may be determined. After a rate of messages received and an amount of messages received during one or more time intervals is determined, they may be compared to a threshold rate and a threshold amount. If the rate of messages received is below the threshold rate and the rate of an amount of messages received is below the threshold amount, then a BECU and/or a Platoon ECU (PECU) may cause an adverse action to occur such as the disabling of full braking, the dissolve of a platoon, and/or the deauthorization of a vehicle to platoon.

In another aspect, without limitation, a system may cause an action such as whether ABS units are operating correctly on more than one trailer. There, a rate of MID11 messages received at a BECU from more than one ABS unit via PLC is determined. Also, an amount of MID11 messages received during one or more time intervals may be determined. In response to a rate of MID11 messages received being below a threshold and an amount of MID11 messages received at a during one or more time intervals being below a threshold an action may occur such as the disabling of full braking, the dissolve of a platoon, and/or the deauthorization of a vehicle to platoon.

It will be appreciated by those skilled in the art that the various features of the present disclosure can be practiced alone or in combination.

These and other features of the present disclosure will be described in more detail below in the detailed description of the disclosure and in conjunction with the following figures.

### BRIEF DESCRIPTION OF THE DRAWINGS

In order to describe the various aspects of the present disclosure, some detailed description now will be provided, by way of illustration, with reference to the accompanying drawings, in which:

FIG. 1 illustrates a diagram of a platooning system, in accordance with some embodiments;

FIG. 2 illustrates a diagram of a platooning system, in accordance with some embodiments;

FIG. 3 illustrates a block diagram of a system including an electronic control unit, in accordance with some embodiments;

FIG. 4 illustrates an example tractor trailer including two trailers, in accordance with some embodiments;

FIG. 5A illustrates an example tractor trailer that includes ABS on all trailers and dollies stopping, in accordance with some embodiments;

FIG. 5B illustrates an example tractor trailer that does not include ABS on all trailers and dollies stopping, in accordance with some embodiments;

FIG. 6 illustrates an example ABS configuration, in accordance with some embodiments;

FIG. 7 illustrates an example message log, in accordance with some embodiments;

FIG. 8 illustrates an example graph including adverse actions, in accordance with some embodiments;

FIG. 9 illustrates an example graph including adverse actions, in accordance with some embodiments;

FIG. 10 illustrates an example graph including adverse actions, in accordance with some embodiments;

FIG. 11 illustrates an example ABS Status Lamp, in accordance with some embodiments;

FIG. 12 illustrates a flow chart of an example process, in accordance with some embodiments;

FIG. 13 illustrates a flow chart of an example process, in accordance with some embodiments;

FIG. 14 illustrates a flow chart of an example process, in accordance with some embodiments; and

FIG. 15 illustrates an example computing system, in accordance with some embodiments.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention, including the description of a plurality of different aspects of the invention, including, in some cases, one or more alternatives. It will be apparent to those skilled in the art that the invention can be practice without implementing all of the features disclosed herein. Further, although many embodiments included in the instant application are related to the concept of platooning, it should be appreciated that many broader applications are envisioned.

Without limitation, the Applicant has proposed various vehicle platooning systems in which a second, and potentially additional, vehicle(s) is/are automatically, or semi-automatically controlled to closely follow a lead/front vehicle in a safe manner. By way of example, U.S. patent application Ser. Nos. 15/605,456, 15/607,902; 13/542,622 and 13/542,627; U.S. Provisional Patent Application Nos. 61/505,076, 62/377,970 and 62/343,819; and PCT Patent Application Nos. PCT/US2014/030770, PCT/US2016/049143, PCT/US2018/41684, and PCT/US2016/060167 describe various vehicle platooning systems in which a trailing vehicle (also referred to herein as a rear vehicle) is at least partially automatically controlled to closely follow a designated lead vehicle. Each of these earlier applications are incorporated herein by reference. These material included in these applications are not to be limiting the instant application in any manner.

One of the goals of platooning is typically to maintain a desired gap between the platooning vehicles and/or a desired relative speed and/or time headway (e.g., a gap may refer to a distance, a headway, or both). Thus, it should be appreciated that, herein, any reference to the term “gap” could refer to a distance, a headway, or both. Further, while the term “maintain” is used throughout this disclosure, maintaining may mean staying within a gap (distance/headway), staying at a gap, and/or keeping at least a certain gap. Further, a desired gap may include a relative distance, time headway, and/or angle/offset. A longitudinal distance and/or time headway is frequently referred to herein as a “target gap”. That is, it is desirable for the trailing vehicle (e.g., a rear vehicle) to maintain a designated gap relative to a specific vehicle (e.g., a lead vehicle). The vehicles involved in a platoon will typically have sophisticated control systems suitable for initiating a platoon, maintaining the gap under a wide variety of different driving conditions, and gracefully dissolving (e.g., ending) the platoon as appropriate. It should be appreciated that herein, a gap may refer to a distance, a time headway, or either.

As described herein, the concept of platooning, also known as convoying, is still in its infancy. Academics have toyed with the concept over the last few decades, but to date there are no commercial systems on the road where a vehicle is at least partially controlled by another vehicle via a vehicle-to-vehicle connection (V2V). The benefits provided by such systems are obvious. Namely, the safety provided by these systems is far greater than a system where a rear vehicle doesn't begin to slow down until its radar or LIDAR sensors determine that a lead vehicle is slowing down, such as with some adaptive cruise control systems. Further, by being able to follow another vehicle at a close distance, in some cases both a rear vehicle and a front vehicle may experience significant fuel savings.

As platoonable vehicles (e.g., vehicles capable of platooning or any type of following based on V2V communication, whether directly following each other, offset in different lanes, and/or with one or more vehicles between them) begin to roll out of the labs and into commercial production, their adoption faces significant challenges. For example, vehicle safety is a must.

In various embodiments described herein, new and improved methods and systems to improve vehicle safety and/or other vehicle functionality (e.g., creating more efficient platooning) are described.

As is well understood in the industry, tractor trailers include various components that communicate with each other—often using different communication protocols such as Society of Automotive Engineers standard SAE J1939 (which defines five layers in the seven-layer OSI network model, which includes the Controller Area Network (CAN) ISO 11898). Tractor-trailers also user power-line communication (PLC) techniques. For example, SAE standard J2497 discusses implementing a bidirectional, serial communications link over the vehicle power supply line. J2497 defines parameters of the serial link relating to hardware and software compatibility such as interface requirements, system protocols, and message format that pertain to PLC communications between tractors and trailers, including how to activate the trailer ABS Indicator Lamps.

While PLC attributes provide various advantages, they also have their drawbacks. For example, if more than one trailer is communicating via PLC to a tractor, messages sent by each trailer (and/or any dollies) may collide with messages sent by other trailers and/or dollies, causing those messages to not reach their destination. E.g., there may not be a scheduler to ensure packages travel to their destination unimpeded.

To ensure that a tractor is sending and/or receiving accurate information from trailers and dollies (e.g., with regard to safety, ABS brakes, brake lights, speed, torque, etc.), various algorithms may be implemented.

As one example, to ensure that a particular number of trailers and dollies are connected to a tractor, and that those trailers and dollies include ABS units that are operating properly, a brake ECU may receive messages transmitted from ABS units on each trailer and dolly. If these messages are not received by a brake ECU (also known as a BECU) and/or a platooning ECU (also known as a PECU), a tractor trailer may perform various actions, which may include the dissolving (e.g., an ending) of a platoon. For example, in some embodiments full braking (as opposed to pulsed braking) may only be available to a trailer if a BECU determines that the trailer's ABS is operating properly. In some embodiments, if only pulsed braking is available (e.g., because full braking is not available), a platoon may dissolve out of an abundance of caution.

In some embodiments, to determine whether ABS units are operating properly, a BECU determines whether it is receiving an anticipated number of messages (e.g., by determining whether a rate at which the BECU is receiving messages indicating ABS units are operating properly (which may be referred to as MID11 messages)).

For example, ABS units may transmit two messages per second indicating they are operating properly (e.g., ABS units may transmit two MID11 messages per second). Thus, if a tractor is pulling two trailers (and a dolly), it should receive six MID11 messages per second (e.g., the tractor/BECU (or in some cases other component) should receive 2 MID11 messages from the first trailer, 2 MID11 messages from the dolly, and 2 MID11 messages from the second trailer).

Unfortunately, because multiple messages are sent over a PLC and collide with each other, typically not all MID11 messages will reach a BECU. As such, for example, anywhere between 1-6+MID11 messages may be received by a BECU when 2 trailers and a dolly are connected to a tractor. In such an example, if a BECU is only receiving 2 MID11 messages per second, it may determine that it cannot guarantee that ABS units are operating properly on a dolly and/or a second trailer. When a BECU cannot guarantee that ABS units are operating properly on a dolly and/or a second trailer, in some embodiments, a PECU, BECU, and/or another component may cause a platoon that a tractor trailer is part of to dissolve.

In some embodiments, a BECU guarantees that 3 ABS units are operating properly when an average number of received MID11 messages is above 4.5 per second. For example, a system may determine that two trailers and a dolly's ABS units are operating properly if, over the course of 10 1-second intervals, an average amount of MID11 messages received per second is at least 4.5. If the average amount of MID11 messages received per second falls below 4.5, because the system determines that it cannot guarantee that 3 ABS units are operating properly, a platoon may dissolve.

In some cases, such a method causes false positives more often than desired. As such, the instant disclosure discusses systems and methods that may improve on this method.

In various embodiments described herein, a system may determine whether ABS units are operating properly based on both: (1) an average number of MID11 messages received per second, and (2) an amount of MID11 messages received per second. The reason for this is simple. Namely, in some embodiments, even if an average number of MID11 messages received per second is below 4.5, if—within a one-second interval—a number of messages received is above 4 (e.g., 5 or 6), then a system may determine that the ABS units are functioning properly because it would be impossible to receive 5 or 6 MID11 messages per second if only one trailer were connected (e.g., a system could not receive more than 2 MID11 messages second if only 1 trailer were connected). Of course, similar logic applies to tractor trailer combinations that include more than 2 trailers, more than 1 dolly, trailers that include multiple ABS units (e.g., wherein 4 or more MID11 messages may be sent by a trailer within one second), etc.

Accordingly, various systems and methods described herein discuss determining whether an adverse action (e.g., a dissolve) should occur not only when (1) an average rate of MID11 messages received are below a certain rate, and (2) when a certain amount of MID11 messages (e.g., 5 or 6) were not received within a one-second interval within a certain period of time.

Of course, embodiments of processes and methods described herein may apply to other applications that use PLC. For example, speed information, refrigeration information, other brake information, trailer content information, etc. could be determined by modifying current methods of determining information based on data sent via a PLC. Further, rates, amounts of verification (e.g., MID11) messages, and other variables may be changed and/or tuned based on a variety of conditions. For example, a required rate of MID11 messages may be 6.5, an amount of MID11 messages received per second may need to be above 8, etc.

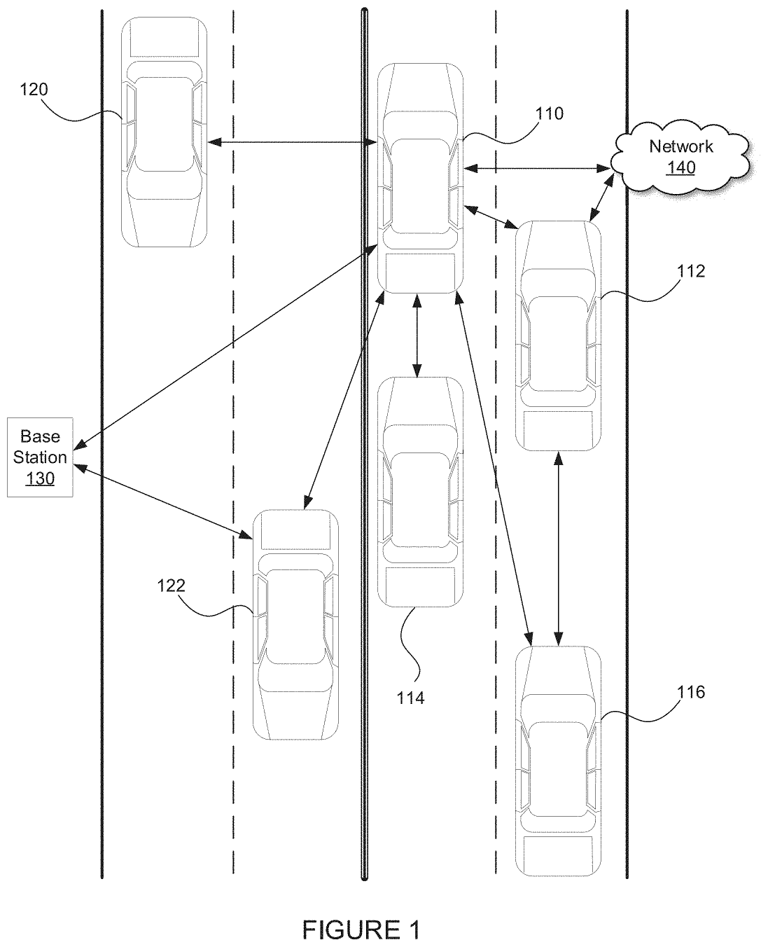

FIG. 1 illustrates a diagram of vehicles transmitting data, in accordance with some embodiments. FIG. 1. depicts multiple vehicles 110, 112, 114, 116, 120, and 122. FIG. 1 also depicts a base station 130 and a network 140. In various embodiments, vehicle 110 may transmit data (also referred to as information) to other vehicles 112, 114, 116, 120, and 122 directly, via base station 130, and/or via network 140. Vehicle 110 may also receive data from other vehicles 112, 114, 116, 120, and 122 directly, via base station 130, and/or via network 140. In some embodiments, a vehicle (e.g., vehicle 112) may retransmit information received from a first vehicle (e.g., vehicle 110) to another vehicle (e.g., vehicle 116) with or without additional information (e.g., information generated at vehicle 112 in addition to information received from vehicle 110).

In various embodiments, vehicles 110, 112, 114, 116, 120, and 122 may be configured to platoon, and may platoon with one another. In some embodiments, vehicles may transmit and/or receive data (e.g., to a NOC and/or fleet management system, etc.) including, but not limited to data indicating: whether they are available to platoon; whether they are platooning; whether a platoon they were part of dissolved; what direction they are traveling; what direction they are predicted (e.g., predetermined/planning on/suggested) to be traveling on for a particular period of time; when they are expected to stop (e.g., predetermined to stop, planning on stopping, suggested stopping time); where they plan on stopping; what route(s) they plan to travel (e.g., a route suggested and/or determined by a system, a route determined by a navigation/mapping system based on their destination such a system may be a rendezvousing system, a fleet management system, a navigation system, etc.); what type of platooning system they are equipped with; how many hours they have been on the road; weather they are capable of following the leader (e.g., if one or more vehicles can platoon without a driver); whether they are capable of being the leader in a follow-the-leader system; whether the vehicle is fully autonomous (e.g., capable of level 4 according to the SAE classification system); how much fuel they have saved; how much money they have saved; an area they are allowed to travel within; an area they are not allowed to travel outside of; whether they are capable of platooning on city streets; whether they are only capable of platooning on a highway; whether they are capable of platooning on non-public roads; whether they are capable of platooning in a particular construction site, mine, forest, etc.; and whether other attributes associated with a vehicle's account allows them to platoon. As should be understood, one or more of these attributes may be used to determine whether a vehicle can platoon with one or more additional vehicles, and whether a vehicle should platoon with one or more additional vehicles. It is contemplated that in some embodiments, a system may rank one or more vehicles with which a vehicle should platoon. In such an embodiment, if a target vehicle (e.g., a vehicle with a high ranking) that a first vehicle attempts to platoon with platoons with second vehicle before the first vehicle is able to platoon with the target vehicle, then the first vehicle may select another (e.g., the next) ranked vehicle that the system would like it to (e.g., determines that it should attempt to) platoon with.

In addition to these factors, other information that a vehicle may transmit and/or receive may include data including, but not limited to data associated with a/an: position, latitude, longitude, altitude, heading, speed, longitudinal and lateral acceleration, relative angle, type of load (e.g., type of materials a vehicle is carrying), brake status, brake pressure, path history, path projection, travel plans, vehicle size, vehicle type, brake type, current operating mode (autonomous or manual), map data, traffic information, GPS augmentation information (e.g., delays from infrastructure), wheel speed, wheel torque, gross torque, net torque, wind, rain, music, video, infotainment system, suspension, axle weight(s), transmission status (e.g., what gear the vehicle is in, what gear the vehicle was in, what gears the vehicle transferred from and to (e.g., fifth gear to fourth gear)), previous transmission status, hybrid vehicle drivetrain (e.g., a parallel hybrid or an electric hybrid), whether a vehicle has an electric motor, battery, electronic throttle control, throttle pedal, brake pedal, power steering, adaptive cruise control, a blowout, interior lighting, exterior lighting, retarder, anti-lock brakes, emergency braking, engine governor, powertrain, gear ratio, wheel size, wheel type, trailer length, trailer type, trailer height, amount of trailers, trailer position, current trailer position, past trailer position, tractor type, tractor height, transceiver type, current fuel, next determined stop, projected miles remaining until fuel tanks are empty, malfunctions, turn signals, LIDAR, radar, ultrasonic sensors, road surface, wheel angle, tire pressure, cabin temperature, engine temperature, trailer interior temperature, camera, fleet of vehicles, NOC, computer vision, other vehicle traveling in the same direction, other vehicle traveling in an opposite direction, and intervening traffic (e.g., cut-ins, also referred to as the situation when a vehicle enters an area between a lead vehicle and a rear vehicle). This information can be used by one or more vehicles, systems, fleets, etc. to determine whether a vehicle may platoon with another vehicle and/or to determine the best vehicle with which a vehicle may platoon. Again, it is contemplated that in some embodiments, a system may rank one or more vehicles with which a vehicle should platoon, and this ranking may be based on vehicle attributes described above. In such an embodiment, if a target vehicle that a first vehicle wishes to platoon with platoons with another vehicle before the first vehicle is able to platoon with the target vehicle, then the first vehicle may move to another (e.g., the next) ranked vehicle that the system would like it to (e.g., determines that it should attempt to) platoon with.

It should be understood that, herein, when a system determines a rendezvous location and/or rendezvous time, that any of these attributes/information/data may be used alone or in combination to determine: whether two or more vehicles can platoon together, a rendezvous location, a rendezvous time, etc.

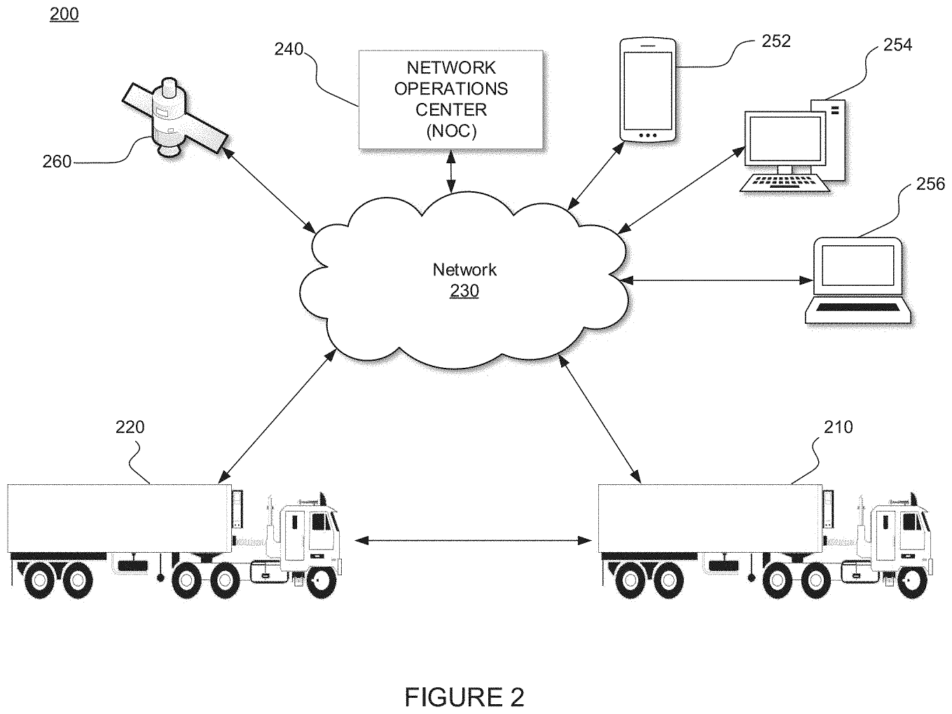

FIG. 2 illustrates an example system 200 including two vehicles capable of platooning and associated communication links. Vehicles 210 and 220 are depicted by trucks which are capable of platooning, and can communicate with each other directly or through network 230. Direct communication between two vehicles can occur wirelessly via Dedicated Short Range Communications (DSRC) (e.g., the IEEE 802.11p protocol), which is a two-way short to medium range wireless communications technology that has been developed for vehicle-to-vehicle (V2V) communications. Of course, other communications protocols and channels may be used in addition to or in place of a DSRC link. For example, the inter-vehicle communications may additionally or alternatively be transmitted over a cellular communications channel such as 4G LTE Direct, 5G, a Citizen's Band (CB) Radio channel, one or more General Mobile Radio Service (GMRS) bands, one or more Family Radio Service (FRS) bands, Wi-Fi, Zigbee and/or any other now existing or later developed communications channels using any suitable communication protocols either alone or in combination.

FIG. 2 also includes a network operations center (NOC) 240. NOC 240 may include one or more locations from which network monitoring, control, and/or management may be exercised over a communication network (e.g., a NOC may be located in the cloud/a multi-tenant environment). NOC 240 can oversee a complex network of vehicles, satellite communications, cellular networks, web applications, and/or management tools. Users of NOC 240 may be responsible for monitoring one or more networks, sub-networks, fleets of vehicles, and/or sub-fleets of vehicles that may require special attention to avoid degraded service. For example, NOC 240 may receive information about various vehicles 210 and 220 such as their locations and attributes, run various programs based on the received information, and send information back to vehicles 210 and 220, including indicating whether they are allowed to platoon.

In addition to NOC 240, client devices 252 (e.g., a smartphone or tablet), 254 (e.g., a desktop computer or terminal), and 256 (e.g., a laptop computer or terminal) may be used to send and/or receive information about vehicles 210 and 220, NOC 240, or information from canonical sources such as the Internet (e.g., Google Maps or another online map provider, a traffic provider, a weather provider, etc.). Client devices can be used to view attributes of vehicles 210 and 220 such as their location, an estimate of their weight, their speed, an amount of engine torque, amount of applied break, a destination, etc.

FIG. 2 also includes a satellite 260, which can send signals to network 230, NOC 240, and/or vehicles 210 and 220. Satellite 260 may be part of a satellite navigation system such as a global navigation satellite system (GNSS). GNSSs include the United States's Global Positioning System (GPS), Russia's GLONASS, China's BeiDou Navigation Satellite System, and the European Union's Galileo. Based on information sent from satellite 260, systems described herein can determine locations of vehicles 210 and 220.

Of course, it should be appreciated that the system described in FIG. 2 is only an example, and that many other configurations may exist. For example, a NOC may assist with the monitoring and control of hundreds or thousands of vehicles, and many types of web applications may exist.

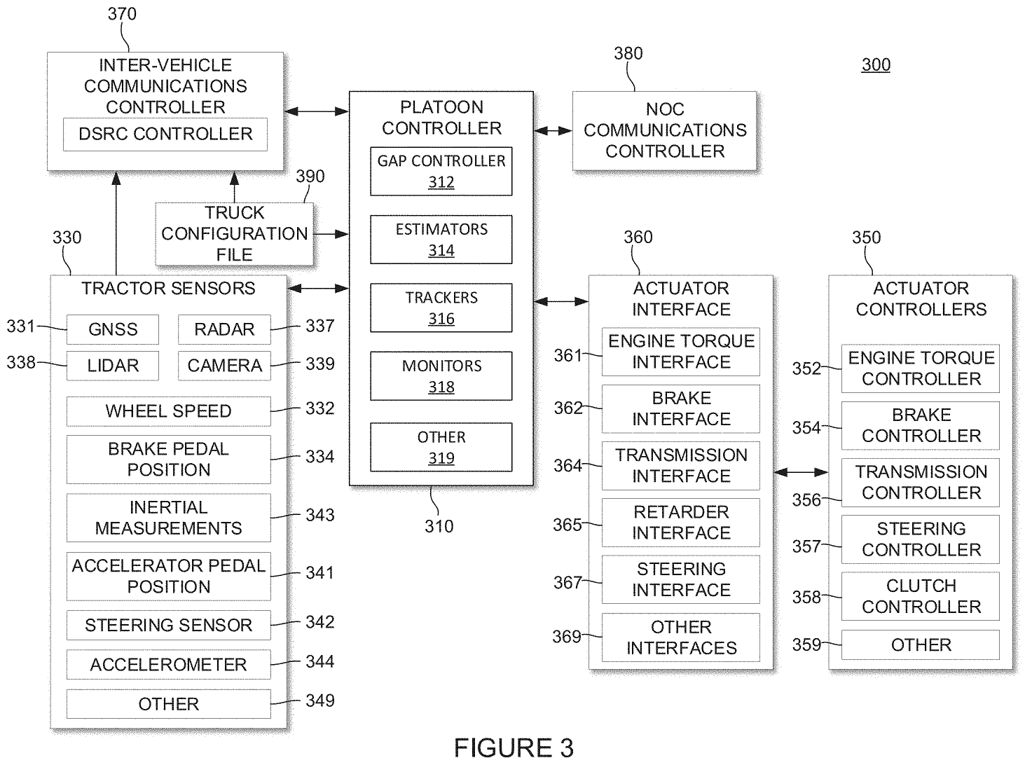

FIG. 3 illustrates and example system 300 including a platoon controller 310 (also referred to as a platoon electronic control unit, a platoon ECU, or a PECU). As described throughout this disclosure, a wide variety of configurations may be used to implement platooning systems described herein. The specific controller design can vary based on the level of automation contemplated for the controller, as well as the nature of and equipment available on the host vehicles participating in the platoon. FIG. 3 illustrates components of one possible configuration.

FIG. 3 diagrammatically illustrates a vehicle control architecture that can be suitable for use with platooning tractor-trailer trucks. The specific controller, or platooning ECU, illustrated is primarily designed for use in conjunction with a platooning system in which both vehicles include an active driver. The driver of the lead vehicle being fully responsible for control of the lead vehicle. In some embodiments the driver of the rear vehicle may be responsible for steering the rear vehicle, but the platoon controller 310 is primarily responsible for controlling the rear vehicle's torque and braking requests during active platooning. However, as discussed herein, it should be appreciated that generally similar control schemes can be used in systems which contemplate more automated control of one or both of the platoon partners or which utilize vehicle control commands other than or in addition to torque and braking requests.

In the example embodiment illustrated in system 300, a platoon controller 310, receives inputs from a number of sensors 330 on the tractor and/or one or more trailers or other connected units, and a number of actuator controllers 350 (also referred to as electronic control units or ECUs) arranged to control operation of the tractor's powertrain and other vehicle systems. An actuator interface 360 may be provided to facilitate communications between the platoon controller 310 and the actuator controllers 350. In some embodiments, one or more of the actuator interfaces 360 may be included in one or more of the actuator controllers 350 (e.g., an actuator interface may be included in an ECU). Platoon controller 310 also interacts with an inter-vehicle communications controller 370 (also referred to as an inter-vehicle communications ECU) which orchestrates communications with the platoon partner and a NOC communications controller 380 (also referred to as a NOC communication ECU) that orchestrates communications with a NOC. The vehicle also may have selected configuration files 390 that include known information about the vehicle.

Some of the functional components of the platoon controller 310 include gap controller 312, a variety of estimators 314, one or more partner vehicle trackers 316 and various monitors 318. In many applications, the platoon controller 310 will include a variety of other components 319 as well.

Some of the sensors utilized by platoon controller 310 may include GNSS unit 331, wheel speed sensors 332, inertial measurement devices 334, radar unit 337, lidar unit 338, cameras 339, accelerator pedal position sensor 341, steering wheel position sensor 342, brake pedal position sensor 343, and various accelerometers 344. Of course, not all of these sensors will be available on all vehicles involved in a platoon and not all of these sensors are required in any particular embodiment. A variety of other sensors 349 (now existing or later developed or commercially deployed) may be additionally or alternatively be utilized by platoon controller 310 in other embodiments.

Many (but not all) of the described sensors, including wheel speed sensors 332, radar unit 337, accelerator pedal position sensor 341, steering wheel position sensor 342, brake pedal position sensor 343, and accelerometer 344 are relatively standard equipment on newer trucks (tractors) used to pull semi-trailers. However, others, such as GNSS unit 331 and lidar unit 338 (if used) are not currently standard equipment on such tractors or may not be present on a particular vehicle and may be installed as needed or desired to help support platooning.

FIG. 3 also illustrates various actuator controllers 350. It should be understood that, in various embodiments, some or all types of controllers may be referred to interchangeably as electronic control units (ECUs). It should, however, be understood that some ECUs may control actuators, some ECUs may control communications, some ECUs may monitor sensors, and some may perform any combination thereof. Thus, it should be appreciated that the system shown in FIG. 3 is merely one of a wide variety of systems that may be used to control platooning.

Some of the vehicle actuator controllers 350 that platoon controller 310 may direct at least in part include engine torque controller 352; brake controller 354; transmission controller 356; steering/automated steering controller 357; and clutch controller 358. Of course, not all of these actuator controllers will be available or are required in any particular embodiment and it may be desirable to interface with a variety of other vehicle actuator controllers 359 that may be available on the vehicle as well. Therefore, it should be appreciated that the specific actuator controllers 350 directed or otherwise utilized by the platoon controller on any particular controlled vehicle may vary widely. Further, the capabilities of any particular actuator controller (e.g. engine torque controller 352), as well as its interface (e.g., the nature and format of the commands, instructions, requests and messages it can handle or generate) will often vary with the make and model of that particular actuator controller. Therefore, an actuator interface 360 is preferably provided to translate requests, commands, messages and instructions from the platoon controller 310 into formats that are appropriate for the specific actuator controller hardware and software utilized on the controlled vehicle. The actuator interface 360 also provides a mechanism for communicating/translating messages, commands, instructions and requests received from the various actuator controllers back to the platoon controller 310. In some embodiments, an appropriate actuator interface may be provided to interact with each of the specific vehicle controllers utilized. In various embodiments, this may include one or more of: an engine torque interface 361; a brake interface 362; a transmission interface 364; a retarder interface 365; a steering interface 367; and/or any other appropriate controller interface 369. In some embodiments, various controllers may be combined (e.g., in the case of a chassis controller, or an engine ECU that also controls a retarder—which may obviate the need for a retarder ECU).

Large trucks and other heavy vehicles frequently have multiple systems for “braking” the truck. These include the traditional brake system assemblies mounted in the wheels of the vehicle—which are often referred to in the industry as the “foundation brakes.” Most large trucks/heavy vehicles also have a mechanism referred to as a “retarder” that is used to augment the foundation brakes and serve as an alternative mechanism for slowing the vehicle or to help prevent the vehicle from accelerating down a hill. Often, the retarder may be controlled by the engine torque controller 352 and in such embodiments, the retarder can be controlled by sending appropriate torque commands (which may be negative) to engine torque controller 352. In other embodiments a separate retarder controller (not shown) may be accessible to, and therefore directed by, platoon controller 310 through an appropriate retarder interface 365. In still other embodiments, the platoon controller 310 may separately determine a retarder command that it sends to the actuator interface 360. In such embodiments the actuator interface will interpret the retard command and pass on appropriate retardation control commands to an Engine ECU or other appropriate vehicle controller.

The communications between vehicles may be directed over any suitable channel and may be coordinated by inter-vehicle communications controller 370. As described above, the DSRC protocol may work well.

The specific information transmitted back and forth between the vehicles may vary widely based on the needs of the controllers. In various embodiments, the transmitted information may include the current commands generated by the platoon controller 310 such as requested/commanded engine torque, and/or requested/commanded braking deceleration 382. They may also include steering commands, gear commands, etc. when those aspects are controlled by platoon controller 310. Corresponding information is received from the partner vehicle, regardless of whether those commands are generated by a platoon controller or other suitable controller on the partner vehicle (e.g., an adaptive cruise control system (ACC) or a collision mitigation system (CMS)), or through other or more traditional mechanisms—as for example, in response to driver inputs (e.g., accelerator pedal position, brake position, steering wheel position, etc.).

In many embodiments, much or all of the tractor sensor information provided to platoon controller 310 is also transmitted to the platoon partner and corresponding information is received from the platoon partner so the platoon controllers 310 on each vehicle can develop an accurate model of what the partner vehicle is doing. The same is true for any other relevant information that is provided to platoon controller 310, including any vehicle configuration information 390 that is relevant to platoon controller 310. It should be appreciated that the specific information transmitted may vary widely based on the requirements of platoon controllers 310, the sensors and actuators available on the respective vehicles, and the specific knowledge that each vehicle may have about itself.

The information transmitted between vehicles may also include information/data about intended future actions as will be discussed in greater detail below. For example, if the lead vehicle knows it is approaching a hill, it may expect to increase its torque request (or decrease its torque request in the context of a downhill) in the near future and that information can be conveyed to a rear vehicle for use as appropriate by the platoon controller 310. Of course, there is a wide variety of other information that can be used to foresee future torque or braking requests and that information can be conveyed in a variety of different forms. In some embodiments, the nature of the expected events themselves can be indicated (e.g., a hill, curve, or exit is approaching) together with the expected timing of such events. In other embodiments, the intended future actions can be reported in the context of expected control commands such as the expected torques and/or other control parameters and the timing at which such changes are expected. Of course, there are a wide variety of different types of expected events that may be relevant to the platoon control.

The communications between the vehicles and the NOC may be transmitted over a variety of different networks, such as a cellular network, various Wi-Fi networks, DSRC networks, satellite communications networks and/or any of a variety of other networks as appropriate. The communications with the NOC may be coordinated by NOC communications controller 380. The information transmitted to and/or received from the NOC may vary widely based on the overall system design. In some circumstances, the NOC may provide specific control parameters such as a target gap. These control parameters or constraints may be based on factors known at the NOC such as speed limits, the nature of the road/terrain (e.g., hilly vs. flat, winding vs. straight, etc.) weather conditions, traffic or road conditions, etc. In other circumstances the NOC may provide information such information to platoon controller 310. The NOC may also provide information about the partner vehicle including its configuration information and any known relevant information about its current operational state such as weight, trailer length, etc.

Lastly, with regard to FIG. 3, configuration file 390 may include a wide variety of information about the host vehicle that may be considered relevant to controller 310. By way of example, some of the information might include the vehicle's specification including such things as engine performance characteristics, available sensors, the existence and/or type of platooning indicators (e.g., lights that indicate a vehicle is platooning), the nature of its braking system, the location of its GNSS antenna relative to the front of the cab, gear ratios, differential ratios etc. In some embodiments, configuration file 390 may include information about a driver, a fleet, a fleet's schedule, a driver rating, a driver's ability to use the system, whether a vehicle has permission to use a system, whether a vehicle is certified to use the system, etc.

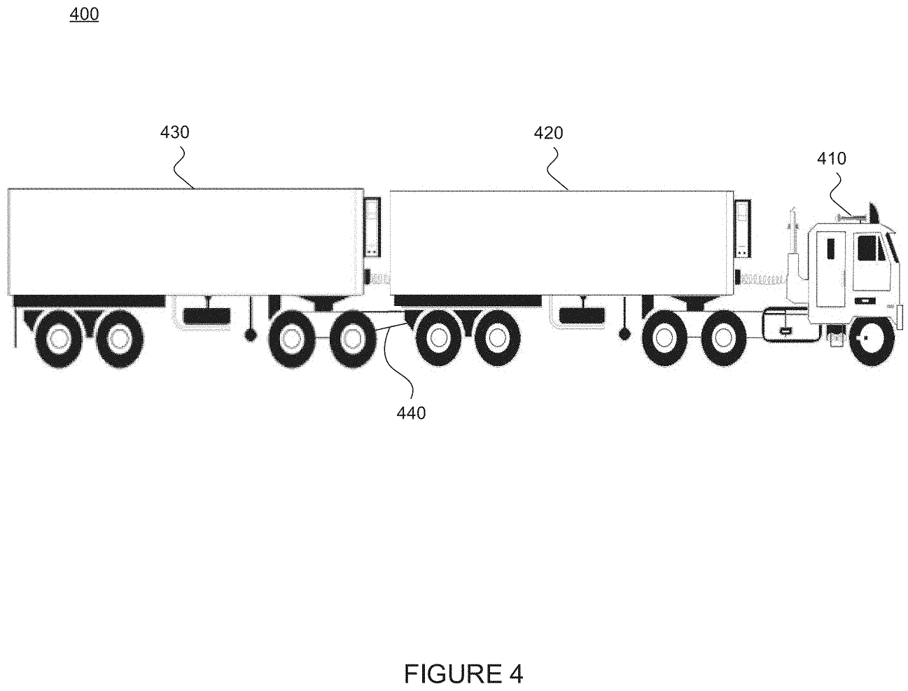

FIG. 4 illustrates an example tractor trailer 400 including two trailers, in accordance with some embodiments. Tractor trailer 400 includes a tractor, 410, a first trailer 420, a second trailer 430, and a dolly 440. A dolly is an unpowered vehicle designed for connection to a trailer. Each of the first trailer 420, second trailer 430, and dolly 400 may send and/or receive data (e.g., information, messages) via PLC. In some embodiments, a serial bus connects first trailer 420, second trailer 430, and dolly 400 to a BECU (not shown).

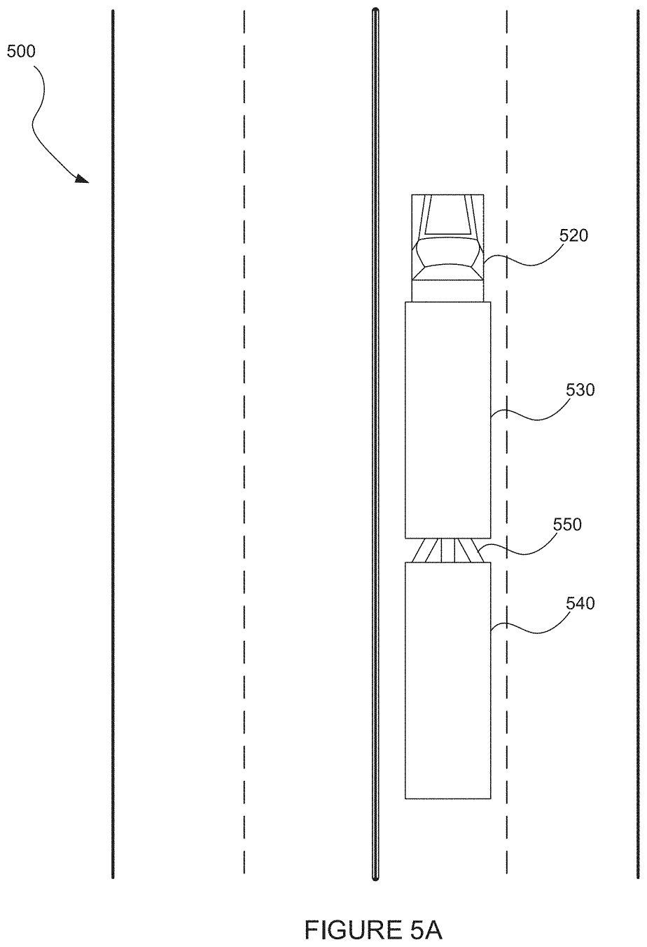

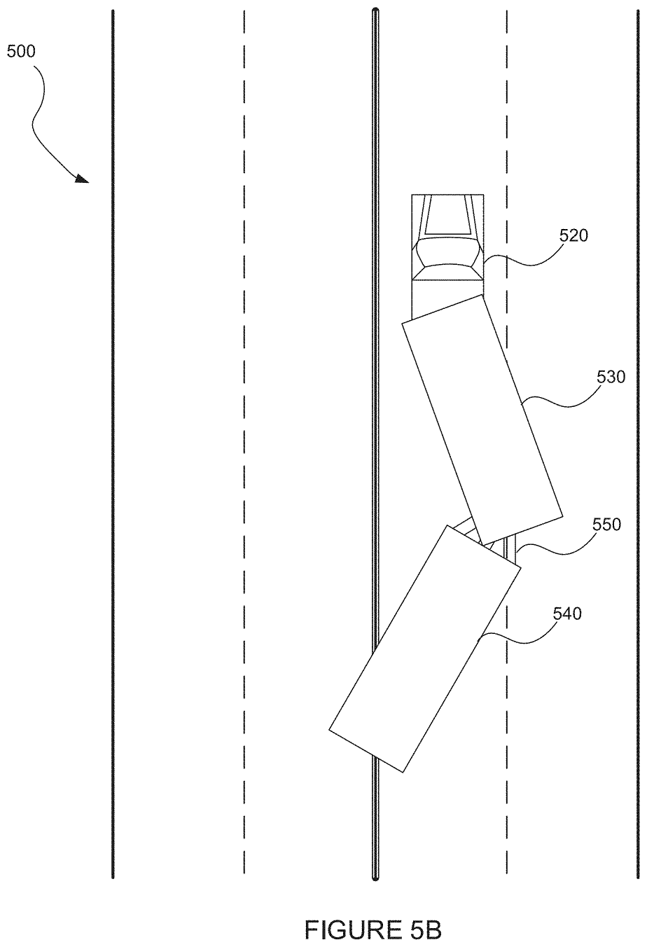

FIG. 5A illustrates an example tractor trailer that includes ABS on all trailers and dollies stopping, in accordance with some embodiments. For example, on the tractor trailer on road 500 stopped in a straight line. In other words, tractor trailer components tractor 520, first trailer 530, second trailer 540, and dolly 505 stayed in a substantially straight line (e.g., the tractor and trailers stopped within their lane).

An Anti-Lock Braking System (ABS) helps prevent a vehicle's (e.g., a trailer and/or trailers's) wheels from locking in the case of excessive actuation of service braking system, especially on slippery roads. ABS may help a driver to keep control of the vehicle during emergency maneuvers and optimizes the stopping distance compared to blocking wheels. In some embodiments, tractor trailer braking systems only allow for full (e.g., hard) braking when a system determines that every trailer and/or dolly include ABS (also referred to as an ABS system and/or ABS brakes for ease of reading).

FIG. 5B illustrates an example tractor trailer that does not include ABS on all trailers and dollies stopping, in accordance with some embodiments. For example, on the tractor trailer on road 500 stopped did not stop in a straight line. In other words, tractor trailer components tractor 520, first trailer 530, second trailer 540, and/or dolly 505 did not stop in a substantially straight line (e.g., the tractor and trailers stopped outside their lane). In some embodiments, this may occur in response to one or more tires on one or more of components tractor 520, first trailer 530, second trailer 540, and/or dolly 505 locking when attempting to stop, which may occur when there is no ABS system.

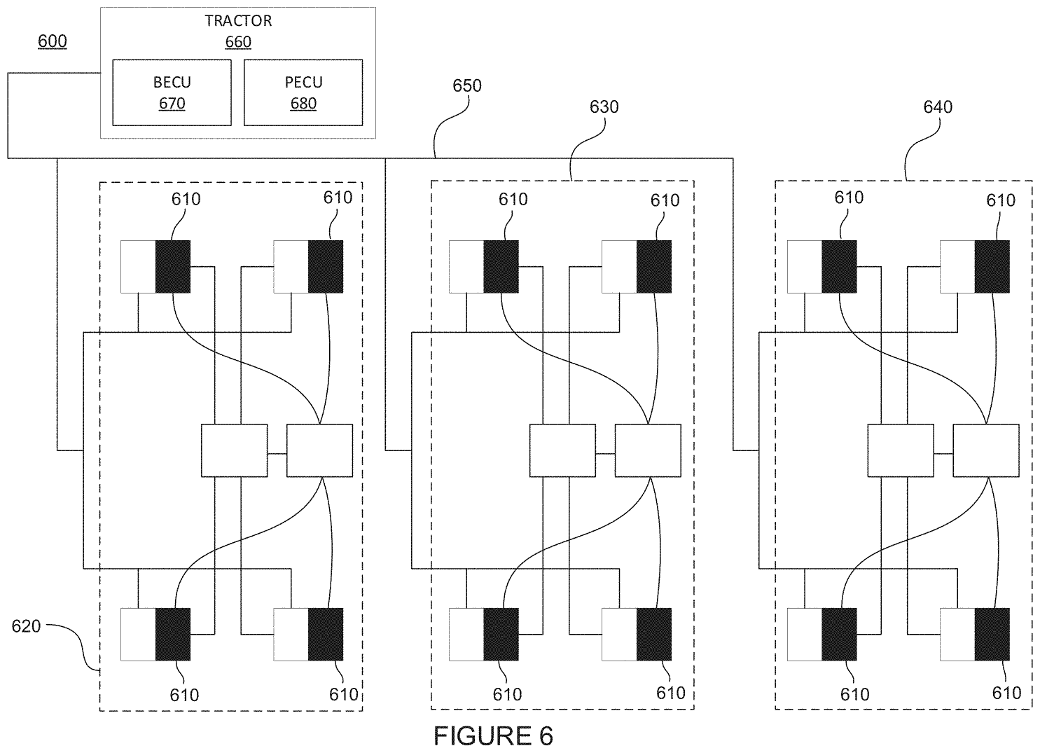

FIG. 6 illustrates an example ABS configuration 600, in accordance with some embodiments. Example ABS configuration 600 illustrates brakes 610 which include an anti-lock braking system in a first trailer 620, dolly 630, and second trailer 640. In various embodiments, information may be sent to and/or from first trailer 620, dolly 630, second trailer 640, and/or brakes 610 via a PLC 650 to tractor 660, BECU 670, and/or PECU 680.

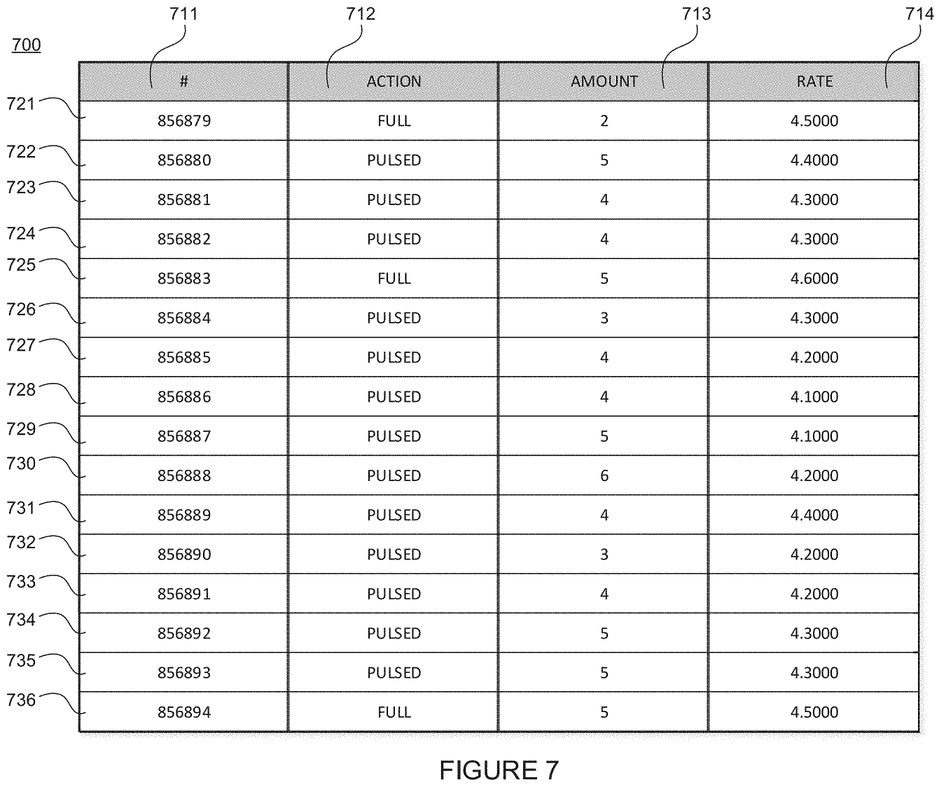

FIG. 7 illustrates an example message log 700, in accordance with some embodiments. Example message log 700 provides information about messages sent via PLC between various components described herein. Example message log 700 includes rows 721-736 that at least in part provide information about messages received (e.g., by a BECU) during a one-second interval. These messages may verify that an ABS unit is operating correctly. For example, each row may indicate an amount of MID11 messages received). Each row may include a message number/ID 711, whether an adverse action 712 is occurring, an amount 713 of messages received during the one-second time interval, and a rate 714 of messages received. In various embodiments, an adverse action may be not providing full braking to trailers and/or a dolly and instead providing pulsed braking, and/or an adverse action may be dissolving a platoon. In some embodiments a rate may be an average amount of MID11 messages received within a one-second interval over the previous ten one-second intervals.

As can be seen in example message log 700, FULL braking is available at a time represented by row 721 because the rate 714 in row 721 is at least 4.5 seconds. At row 722, an adverse action (e.g., pulsed braking) is applied because the rate 714 in row 722 is below 4.5 seconds. Of course, any average may be used to cause any action (adverse or otherwise) (e.g., an average amount speed of a wheel (provided via PLC) above a certain speed may cause a vehicle's engine ECU (EECU) to perform an action). Further, any number shown in FIG. 7 may be higher or lower based on the application, and verification messages do not need to be MID11 messages. Also, it is worth mentioning that in some embodiments, if an MID10 message (e.g., a message indicating an ABS is malfunctioning) is received at a BECU and/or other component, an adverse action may occur such as a platoon dissolve.

When rate 714 drops below 4.5 second, pulsed braking is applied (e.g., at rows 722-724 and 726-735). The reason pulse braking is applied is because this particular method assumes that if the rate is below 4.5 per second a second trailer and dolly may not be connected (or at least receiving power). In other words, this method does not guarantee that a dolly and a second trailer have ABS brakes when a rate of MID11 messages is below 4.5 messages per second.

However, as described herein, it is contemplated that, in some embodiments, if an amount of messages received in a one-second interval is greater than 4.5, then components attached over a PLC to a first trailer must exist—since a single trailer does not send 5 or 6 MID11 messages in a one-second interval.

Thus, embodiments described herein articulate a method that does not produce as many false positives (e.g., where a rate under 4.5 causes an adverse action by itself, regardless of an amount of MID11 messages received over a previous one-second interval).

Herein, a method is contemplated wherein response to an average rate being below an amount (e.g., an average MID11 receipt rate of 4.5 MID11 messages per second): (1) a determination is made as to whether more than a threshold amount of messages (e.g., four MID11 messages) were received in the previous interval (e.g., the previous one-second interval). If there were more than a threshold amount of messages (e.g., four MID11 messages) received in the previous interval (e.g., the previous one-second interval), no adverse action is applied. (2) A determination is made as to whether this is the first instance of a rate falling below a threshold amount of messages (e.g., 4.5 MID11 messages per second). If it is the first instance of the rate falling below the threshold amount of messages, no adverse action (e.g., ending full braking capability/ending platooning) will be applied, but a counter will start. The counter may determine whether an amount of messages received within a certain amount of the previous intervals (e.g., the previous three one-second intervals) exceeds a threshold (e.g., 4 messages). (3) In response to the counter not having a threshold amount of messages received within one of the previous intervals (e.g., the previous one-second intervals), then an adverse action such as pulsed braking or the dissolve of a platoon may occur.

As an example of why this method may reduce the number of false negatives (adverse actions when not necessary), take the following situation:

If in a first on-second interval, an amount of messages received were 6, a rate would be 6. If the next one-second interval received 2 messages, the rate would be 4, and an adverse action would occur. If the next one second interval included 6 received messages, the rate would be 4.666, which would reverse the adverse action, or at least not causes an adverse action. If the next one second interval included 2 received messages the rate would be 4. If the next one second interval included 6 received messages, the rate would be 4.4, and so on—causing adverse actions even though there must be two trailers and a dolly (for example) since the received messages is often 6.

In other words, if an amount of received messages oscillated between 6 and 2 (or 5 and 3 for that matter), a method that only relied on an average (which may be referred to as method 1) would cause false negatives more often than and a method that relied on an average and discarded that average if more than 4 messages were received in one of the previous 3 one-second intervals (which may be referred to as method 2) would not cause false negatives as often. In fact, the latter method may respond to a loss in power/communication with ABS units (e.g., cause an adverse action) faster than the former method.

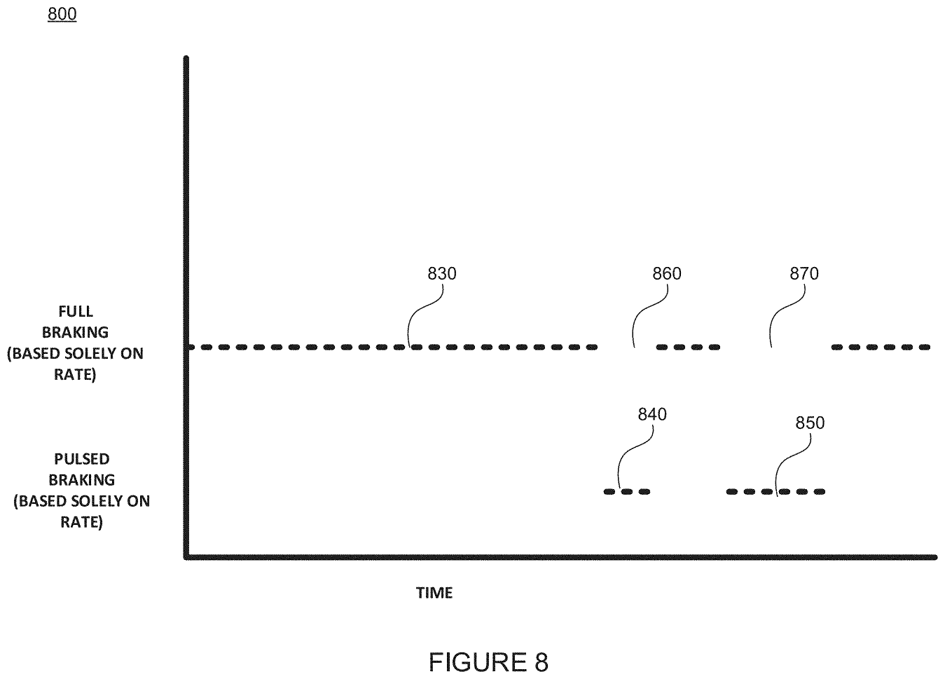

FIGS. 8-10 provide addition examples shown as graphs.

FIG. 8 illustrates an example graph 800 including adverse actions, in accordance with some embodiments. Example graph 800 includes instances where full braking was allowed (e.g., using a method that only relied on a rate of messages before causing an adverse action) 830, and instances where full braking was not allowed and pulsed braking was (e.g., using a method that only relied on a rate of messages before causing an adverse action) 840 and 850. Sections 860 and 870 indicate instances in time where full braking was not allowed (using a method that relied only on a rate of messages to determine whether an adverse action should occur).

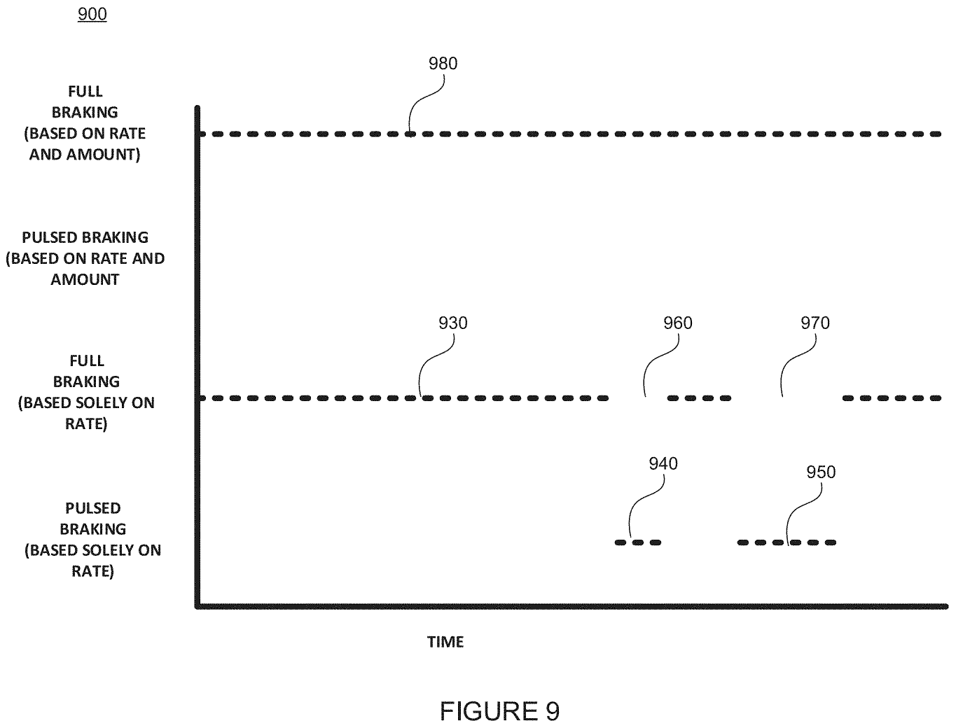

FIG. 9 illustrates an example graph 900 including adverse actions, in accordance with some embodiments. Example graph 900 includes instances where full braking was allowed (e.g., using a method that only relied on a rate of messages before causing an adverse action) 930, and instances where full braking was not allowed and pulsed braking was (e.g., using a method that only relied on a rate of messages before causing an adverse action) 940 and 950. Sections 960 and 970 indicate instances in time where full braking was not allowed (using a method that relied only on a rate of messages to determine whether an adverse action should occur). Example graph 900 also includes instances where full braking was allowed (e.g., using a method as described above (e.g., method 2) wherein an adverse action was caused when a rate was below a certain amount and an amount of messages received in each time interval in a set of previous time intervals) 980.

In this example, a rate of received packets fell below a threshold (e.g., 4.5 per second) at instances 940/960 and 950/970, but a counter (e.g., a data structure that includes information about received messages in a previous set of time intervals) included a representation of a time interval that included more than a threshold (e.g., 4) received messages (e.g., MID11 messages).

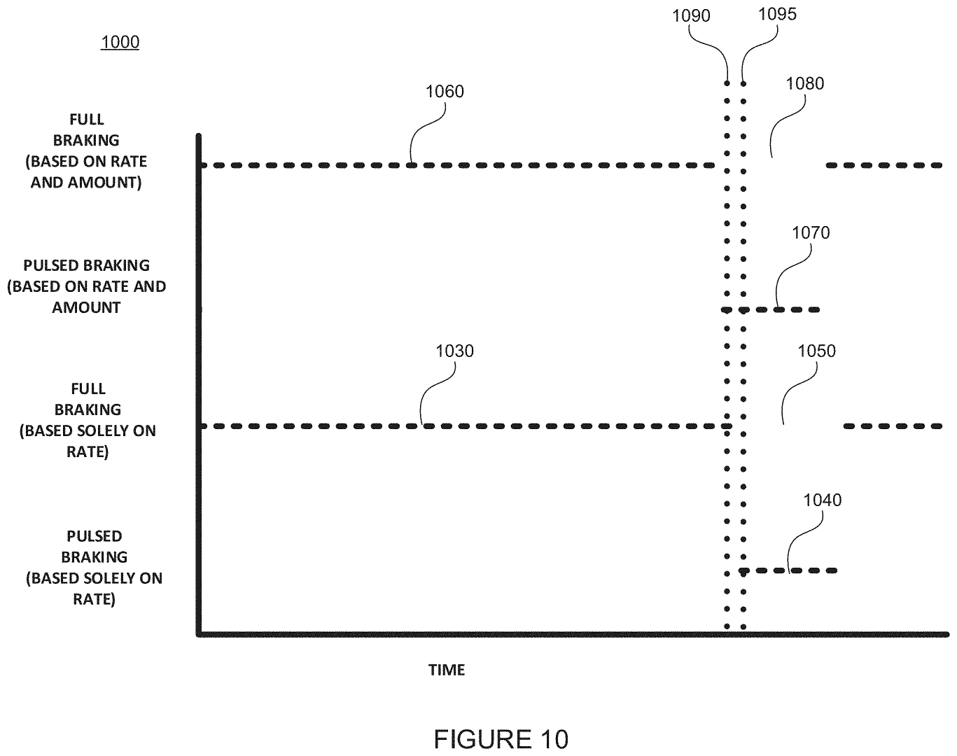

FIG. 10 illustrates an example graph 1000 including adverse actions, in accordance with some embodiments. Example graph 1000 includes instances where full braking was allowed (e.g., using a method that only relied on a rate of messages before causing an adverse action) 1030, and instances where full braking was not allowed and pulsed braking was (e.g., using a method that only relied on a rate of messages before causing an adverse action) 1040. Section 1050 indicates instances in time where full braking was not allowed (using a method that relied only on a rate of messages to determine whether an adverse action should occur). Example graph 1000 includes instances where full braking was allowed (e.g., using a method as described above (e.g., method 2) wherein an adverse action was caused when a rate was below a certain amount and an amount of messages received in each time interval in a set of previous time intervals) 1060. Also, example graph 1000 includes section 1070 that indicates instances in time where full braking was not allowed and pulsed braking was (using a method as described above (e.g., method 2) wherein an adverse action was caused when a rate was below a certain amount and an amount of messages received in each time interval in a set of previous time intervals). Section 1080 indicates instances in time where full braking was not allowed (using a method as described above (e.g., method 2) wherein an adverse action was caused when a rate was below a certain amount and an amount of messages received in each time interval in a set of previous time intervals).

In this example, a rate of received packets fell below a threshold (e.g., 4.5 per second) at instances 1040/1050. Further, a time interval that included more than a threshold received messages (e.g., MID11 messages) was not received at instances leading up to instances 1070/1080. In some embodiments, because a method such as method 2 includes a counter that only assesses three intervals of time (e.g., one-second intervals) as opposed to ten intervals (e.g., when taking an average as with method 1 described above), a method such as method 2 may determine that there is an error in power/communication between an ABS and a BECU sooner.

In this example, at line 1090 indicates the time at which a method (e.g., method 2) wherein an adverse action was caused when a rate was below a certain amount and an amount of messages received in each time interval in a set of previous time intervals caused an adverse action. Line 1095 indicates the time at which a method where only a rate is assessed (as with method 1) causes an adverse action.

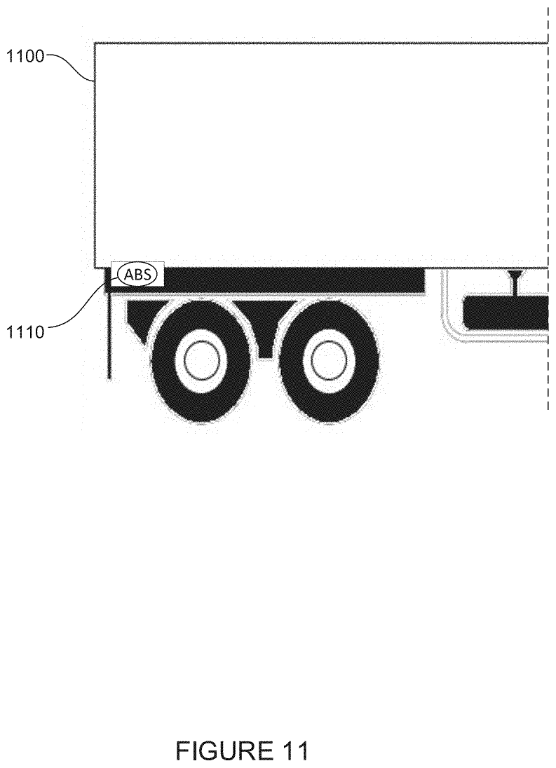

FIG. 11 illustrates an example trailer 1100 with an ABS lamp 1110. In some embodiments, the lights may receive power vis PLC when their ABS systems are sending MID11 messages. Drivers may inspect these lamps before driving. In some embodiments, if a rate and/or amount of messages received at a BECU (or other component, which may include or be included in ABS lamp 1100) that is below a certain amount the lamp may not illuminate (whether using a method such as method 1 or method 2). In various embodiments, these lamps may be included on at least one trailer and/or at least one dolly.

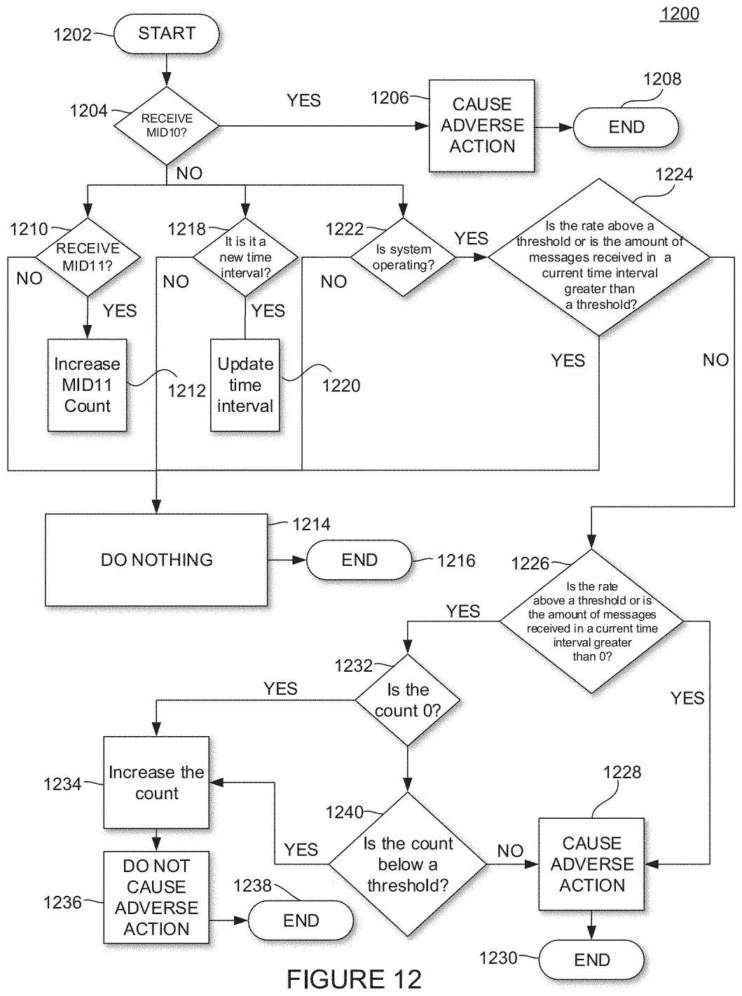

FIG. 12 illustrates a flowchart of an example process, in accordance with some embodiments. Example process 1200 includes a method for determining whether to cause an adverse action or to do nothing in response to information derived from a PLC, in accordance with various embodiments. While the various steps in the flowchart is presented and described sequentially, one of ordinary skill will appreciate that some or all of the steps can be executed in different orders and some or all of the steps can be executed in parallel. Further, in one or more embodiments of the invention, one or more of the steps can be omitted, repeated, and/or performed in a different order.

Moreover, in some embodiments a portion of a step may be omitted and/or added. For example, step 1224—where a determination is made as to whether a rate is above a threshold or an amount of messages received in a current time interval is above a threshold—may only call for a determination as to whether a rate is above a threshold, or it may only call for a determination as to whether an amount of messages received in a current time interval are greater than a threshold. Thus, in such an example, even if a rate is above a threshold, if an amount of messages received in a current time interval is below a threshold the determination will result in “no”, and process 1200 may proceed from step 1224 to step 1226.

It should also be understood that, in some embodiments, process 1200 may be a loop. In some examples, process 1200 may occur every time a message (e.g., an MID11 message) is received. For example, in response to receiving a message, a determination may be made as to whether it is an MID10 message, the number of messages received in a current time interval may be incremented, etc.

Accordingly, the specific arrangement of steps shown in FIG. 12 should not be construed as limiting the scope of the invention. In one or more embodiments, the steps of FIG. 12 can be performed by example systems 100, 200, 300, and/or computing system 1500.

In step 1202 in some embodiments, process 1200 starts. In some embodiments, it is assumed that a certain amount of messages (e.g., MID11 messages) have already been sent and that a system is currently operating correctly. In other words, at step 1202 it is assumed that a message rate (e.g., column 714 of each row of table 700) and an amount of messages in each cell of a buffer (e.g., wherein a cell of a buffer is an object (and wherein each object constitutes the buffer) and each object includes an amount of received messages in a time interval (e.g., column 713 of each row of table 700)).

In step 1204 in some embodiments, a determination is made as to whether a received message is an MID10 message. If yes, in some embodiments, process 1200 proceeds to step 1206.

In step 1206 in some embodiments, an adverse action occurs, and process 1200 proceeds to step 1206. An adverse action may include causes allowing a tractor only having the authority to pulsed brake, instead of having full braking authority. In some embodiments, an adverse action may include the dissolve of a platoon or the inability to initiation a platoon.

In step 1208 in some embodiments, process 1200 ends.

In step 1210 in some embodiments, if an MID10 message was not received, a determination is made as to whether a received message is an MID11 message. If the received message is an MID11 message, a count of MID11 messages is increased at step 1212 (e.g., a cell of a message buffer representing the current time interval increases an amount of MID11 messages received during the current time interval by one). If not, then process 1200 does nothing at step 1214.

In step 1212 in some embodiments, the MID11 count for a time period (e.g., a one-second interval) is increased.

In step 1214 in some embodiments, the system does nothing, and continues as it is currently operating. Process 1200 then ends at step 1216.

In step 1216 in some embodiments, process 1200 ends.

In step 1218 in some embodiments, a determination is made as to whether it is time for the system to update the rate (e.g., a determination is made as to whether a new time interval should begin). If yes, in some embodiments, the process 1200 proceeds to step 1220. If not, in some embodiments, process 1200 proceeds to step 1214 and does nothing, then ends process 1200 at step 1216.

In step 1220 in some embodiments, a current time interval is incremented. For example, the previous one-second interval ends and a new one-second interval begins. In some embodiments, at step 1220, (1) each cell in the message buffer is populated with the values in each cell's previous cell (e.g., cell one is populated with information included in cell two, such as the amount of MID11 messages received during the one-second time interval represented by cell two, cell two is populated with information included in cell three, such as the amount of MID11 messages received during the one-second time interval previously represented by cell three, and the information that was populating cell one is discarded), (2) a cell in a message buffer representing the current time is populated with an amount of MID11 messages received during the current time interval (e.g., cell three is populated with the amount of messages received in during current time interval), (3) the total amount of messages included in a message buffer is updated to include the total amount of messages included in the message buffer cells (e.g., cells one-three), (3) an average message rate may be updated to include the new total amount of messages included in the message buffer cells divided by the number of cells in the message buffer, and (4) the MID11 count for the new time interval restarts at 0.

In step 1222, in some embodiments, a determination is made as to whether a system is operating correctly and a driver has selected a number of trailers attached to a trailer. If this has not happened, in some embodiments, process 1200 may continue to step 1214 and nothing may occur. In some embodiments, if this has happened process 1200 may continue to step 1224. Of course, a variety of other actions, attributes of a system, etc. may be present and/or occur to cause process 1200 to proceed to step 1224. Moreover, in some embodiments, it is contemplated that when process 1200 proceeds to step 1222 it may automatically proceed to step 1224.

In step 1224 in some embodiments, a determination is made as to whether a rate is above a threshold rate or if an amount of messages received in a current time interval is greater than a threshold amount of messages received in a current time interval (e.g., if the number of messages included in a current cell of a buffer is above a threshold) In some embodiments, the threshold rate is 4.5 MIDI 1 messages per second, and the threshold amount of messages received in a current time interval is 4.5. If a rate is above a threshold rate then nothing is done and process 1200 proceeds to step 1214 and process 1200 ends at step 1216. If the amount of messages received in a current time interval is above greater than a threshold amount of messages received in a current time interval then nothing is done and process 1200 proceeds to step 1214 and process 1200 ends at step 1216. In some embodiments, if either the rate is below a threshold rate and an amount of messages received in a current time interval is less than a threshold amount of messages received in a current time interval then process 1200 proceeds to step 1226. In some embodiments, if process 1200 proceeds to step 1214, a counter indicating how many times process 1200 did not proceed from step 1224 to step 1214 is reset to 0.

In step 1226 in some embodiments, a determination is made as to whether the rate is above a threshold rate or the amount of messages received in a current time interval is greater than 0. If the rate is above a minimum threshold and the amount of messages received in a current time interval is above 0, then process 1200 may proceed to step 1228 where an adverse action occurs (e.g., as in step 1206), and process 1200 ends at step 1230.

It should be understood by one skilled in the art that if process 1200 (e.g., loop 1200) proceeds to step 1226 more than a threshold number of times, an adverse action may occur because this could be indicative of an abnormal function wherein step 1224 does not proceed to step 1214 within a given amount of loops through process 1200 (e.g., process 1200 is not determining that a rate is above a threshold or an amount of messages received in a current (or previous) time interval is above a threshold).

In step 1228 in some embodiments, a system causes an adverse action such as switching to pulsed braking, dissolving a platoon, and/or disabling an ability to platoon. In some embodiments, process 1200 then proceeds to step 1230 and ends.

In step 1230 in some embodiments, process 1200 ends.

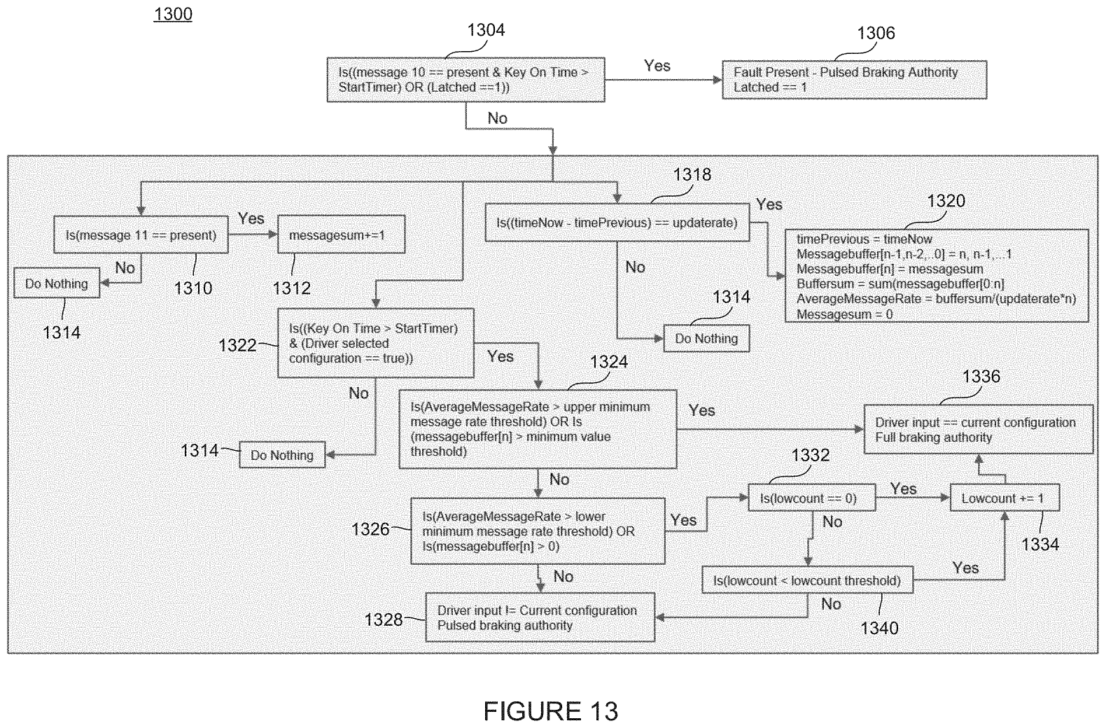

In step 1232 in some embodiments, a determination is made as to whether how many times process 1200 did not proceed from step 1224 to step 1214 (e.g., lowcount==0 as described in FIG. 13). This is because, in some embodiments, if process 1200 does not proceed from step 1224 to step 1214 then a rate is not above a threshold and an amount of MID11 messages received in a time interval (or a previous time interval, in some embodiments) is not above a threshold and thus process 1200 does not refrain from performing an action (which may typically be adverse). Thus, if yes, process 1200 continues to step 1234, where the count is increased and an adverse action is not caused at step 1236.

In step 1234 in some embodiments, a count indicating that process 1200 has not entered step 1226 a threshold number of times is increased, and an adverse action is not caused at step 1236. Process 1200 then ends at step 1238.

At step 1236 in some embodiments, a system may not cause an adverse action. For example, in some embodiments a system may continue to allow for full braking, or a system may continue to authorize and/or reauthorize a vehicle and/or a set of vehicles to platoon.

At step 1238 in some embodiments, process 1200 ends.

At step 1240 in some embodiments, a determination is made as to whether the amount of times process 1200 has entered step 1226 is below a threshold amount. If the count is below a threshold, process 1200 continues to step 1234 where the count is increased, and then to step 1236 where an adverse action does not occur, then process 1200 ends at step 1238.

FIG. 13 illustrates a flowchart of an example process, in accordance with some embodiments. Example process 1300 includes a method for determining whether to cause an adverse action, in accordance with various embodiments. In some embodiments, steps in process 1300 may correspond to steps in process 1200 (e.g., such correspondence may be determined by similar step numbers). While the various steps in the flowchart is presented and described sequentially, one of ordinary skill will appreciate that some or all of the steps can be executed in different orders and some or all of the steps can be executed in parallel. Further, in one or more embodiments of the invention, one or more of the steps can be omitted, repeated, and/or performed in a different order. Accordingly, the specific arrangement of steps shown in FIG. 13 should not be construed as limiting the scope of the invention. In one or more embodiments, the steps of FIG. 13 can be performed by example systems 100, 200, 300, and/or computing system 1500.

Moreover, in some embodiments a portion of a step may be omitted and/or added. For example, step 1324—where a determination is made as to whether a rate is above a threshold or an amount of messages received in a current time interval is above a threshold—may only call for a determination as to whether a rate is above a threshold, or it may only call for a determination as to whether an amount of messages received in a current time interval are greater than a threshold. Thus, in such an example, even if a rate is above a threshold, if an amount of messages received in a current time interval is below a threshold the determination will result in “no”, and process 1300 may proceed from step 1324 to step 1326.

It should also be understood that, in some embodiments, process 1300 may be a loop. In some examples, process 1300 may occur every time a message (e.g., an MID11 message) is received. For example, in response to receiving a message, a determination may be made as to whether it is an MID10 message, the number of messages received in a current time interval may be incremented, etc.

As mentioned, some steps in process 1300 may correspond to steps in process 1200. In some embodiments, if a step in process 1200 corresponds to a step in process 1300 then actions, attributes, and/or descriptions associated with that step included in process 1200 may correspond to actions, attributes, and/or descriptions of the corresponding step in process 1300 and vice-versa.

In step 1304, which may correspond with step 1204, in some embodiments, process 1300 starts and a determination is made as to whether a received message is an MID10 message. If so, process 1300

a determination is made as to whether a received message is an MID10 message. If yes, in some embodiments, process 1300 proceeds to step 1306.

In step 1306, which may correspond with step 1206, in some embodiments, a fault is detected due to the reception of an MID10 message and an adverse action occurs. For example, full braking authority may be revoked and only pulsed braking authority may be provided. In some embodiments, a platoon may be dissolved and/or a vehicle may not have authorization to platoon.

In step 1310, which may correspond with step 1210, in some embodiments, a determination is made as to whether a received message is an MIMI message. If no, process 1300 proceeds to step 1314 and nothing is done. If it yes, then an amount of messages included in a current time interval is increased by one (e.g., messagesum+=1) at step 1312.

In step 1312, which may correspond with step 1212, in some embodiments, an amount of messages included in a current time interval is increased by one (e.g., messagesum+=1).

In step 1314, which may correspond with step 1214, in some embodiments, nothing is done.

In step 1318, which may correspond with step 1218, in some embodiments, a determination is made as to whether a current time subtracted by a previous time is equal to an amount of time at which a rate should be updated (e.g., if ((timeNow−timePrevious)==updaterate)) (e.g., a rate should be updated every one second). If no, nothing is done at step 1324. If yes, process 1300 may proceed to step 1320.

In step 1320, which may correspond with step 1200, in some embodiments, one or more of the following may occur: (1) the previous time interval is updated to be the current time interval (e.g., timePrevious=timeNow, (2) the contents of each cell in a message buffer is replaced with the contents of the next cell in the content buffer (e.g., Messagebuffer[n−1, n−2, . . . , 0]=n, n−1, . . . , 1), (3) the contents of the cell representing the current interval of time in the message buffer is populated with the current amount of messages received in the current time interval (e.g., Messagebuffer[n]=messagesum), (4) the total amount of messages included in the buffer is updated (e.g., Buffersum=sum(Messagebuffer[0:n])), (5) the rate may be populated with the total amount of messeges included in the buffer divided by the length of a time interval (e.g., updaterate and/or one second) multiplied by the amount of messages included in a cell representing the current time interval, and (6) an amount of messages in a current time period is set to 0 (e.g., Messagesum=0).

In step 1322, which may correspond with step 1222, in some embodiments, a determination is made as to whether the time that the system is running is greater than the start timer of the system, and whether a driver has selected a trailer configuration (e.g., if (Key On Time >StartTimer & (Driver selected configuration==true)). If either of these have not happened, then process 1300 moves to step 1314 and does nothing. If either of this are true, then process 1300 moves to step 1324.

In step 1324, which may correspond with step 1224, in some embodiments, a determination may be made as to whether an average message rate for a current time interval is greater than a rate threshold or an amount of MID11 messages received in a current time interval is greater than a threshold (e.g., if (AverageMessageRate >upper minimum rate threshold) OR if (messagebuffer[n]>minimum value threshold)). If yes, then process 1300 moves to step 1336. If no, the process 1300 moves to step 1326. In some embodiments, if yes, then the counter (e.g., lowcount) indicating how many times the determination was no (e.g., where process 1300 would move to step 1326) is reset to 0.

In step 1326, which may correspond with step 1226, in some embodiments, a determination is made as to whether a message rate is greater than a threshold (which could be a minimum threshold (also referred to as a low threshold)) or if an amount of messages in a current time interval is more than 0 (e.g., if (AverageMessageRate >lower minimum message rate threshold) OR if (messagebuffer[n]>0)). If no, then process 1300 moves to step 1328. If yes, then process 1300 moves to step 1332. It should be understood by one skilled in the art that if process 1300 (e.g., loop 1300 (or 1200 for that matter)) proceeds to step 1326 more than a threshold number of times, an adverse action may occur because this could be indicative of an abnormal function wherein step 1324 does not proceed to step 1336 within a given amount of loops through process 1300 (e.g., process 1300 is not determining that a rate is above a threshold or an amount of messages received in a given time interval is above a threshold).

In step 1328, which may correspond with step 1228, in some embodiments, the input a driver entered with regard to a number of trailers does not equal the current configuration and/or an adverse action occurs. For example, full braking authority may be revoked and only pulsed braking authority may be provided and/or a platoon may dissolve and/or a vehicle may not be authorized to form part of a platoon.

In step 1332, which may correspond with step 1232, in some embodiments, a determination is made as to whether the current iteration of process 1300 (e.g., loop 1300) is low (e.g., below a threshold and/or equal to 0 (e.g., lowcount=0)). If yes, then process 1300 moves to step 1334. If no, then process 1300 moves to step 1336.

In step 1334, which may correspond with step 1234, in some embodiments, an amount of times that process 1300 has occurred (e.g., loop 1300) is incremented (e.g., Lowcount+=1). In some embodiments, this number is incremented because there has not been an instance in a particular number of loops wherein an average message rate is above a threshold or a amount of messages received in a time interval is above a threshold. Thus, process 1300 then proceeds to step 1336.

At step 1336, which may correspond with step 1236, in some embodiments, a driver input (e.g., a driver's selection of a trailer configuration including a number of trailers) is correct, and a system provides full braking authority and/or authorizes/reauthorizes a vehicle to form part of a platoon.

At step 1340, which may correspond with step 1240, in some embodiments, a determination is made as to whether an amount of times process 1300 has entered step 1326 (e.g., how many times a rate was not above a threshold and an amount of messages received within one or more time intervals was not above a threshold) is less than a threshold (e.g., if (lowcount <lowcount threshold). Such a determination is important because it may indicate whether a rate is ever above a threshold or a number of messages received within a time interval is ever above a threshold (if this never happens, there likely is an error). Thus, if yes, then process 1300 proceeds to step 1334. If no, then process 1300 proceeds to step 1328.

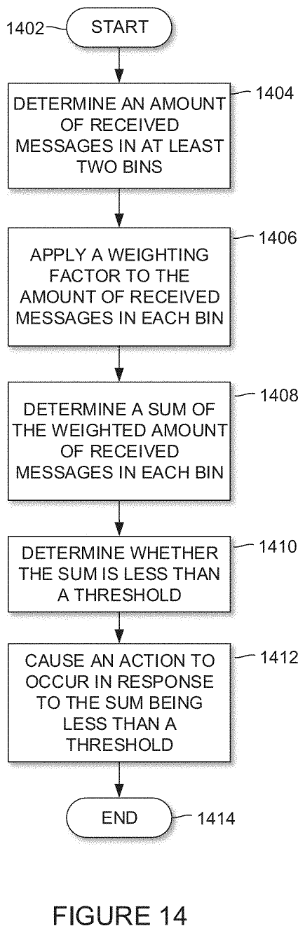

FIG. 14 illustrates a flowchart of an example process, in accordance with some embodiments. Example process 1400 includes a method for determining whether to cause an action, in accordance with various embodiments. In some embodiments, steps in process 1400 may correspond to steps in process 1400 (e.g., such correspondence may be determined by similar step numbers). While the various steps in the flowchart is presented and described sequentially, one of ordinary skill will appreciate that some or all of the steps can be executed in different orders and some or all of the steps can be executed in parallel. Further, in one or more embodiments of the invention, one or more of the steps can be omitted, repeated, and/or performed in a different order. Accordingly, the specific arrangement of steps shown in FIG. 14 should not be construed as limiting the scope of the invention. In one or more embodiments, the steps of FIG. 13 can be performed by example systems 100, 200, 300, and/or computing system 1500.

In step 1402, in some embodiments, process 1400 begins.

In step 1404, in some embodiments, an amount of received messages in at least two bins is determined. In some embodiments, a bin may be a cell that is part of a buffer (e.g., an array or other data structure). Each bin may represent a time interval (e.g., a one-second time interval) and may include an amount of messages (e.g., MID11 messages) received within the time interval represented by the bin.

In step 1406, in some embodiments, a weighting factor may be applied to the amount of messages received in each bin. For example, a weighting factor may be 1, or it may be 0.1. If a bin includes 5 received messages and a weighting factor is 1 is applied to that bin, then the amount of received messages in that bin after applying the weighting factor would be 5 (e.g., 1×5). If a bin includes 5 received messages and a weighting factor of 0.1 is applied to that bin, then the amount of received messages in that bin after applying the weighting factor would be 0.5 (e.g., 0.1×5).

In step 1408, in some embodiments, a sum of the weighted amount of received messages in each bin is determined. For example, if two bins include 5 messages (e.g., where each bin included 5 messages and a weighting factor of 1 was applied) and another two bins include 0.5 messages (e.g., where each bin included 5 messages and a weighting factor of 0.1 was applied), then the sum of those four bins would be 11 (e.g., (2×(5×1))+(2×(5×0.1))).

In some embodiments, the weighting factor applied to messages in bins representing more recent time intervals is greater than or equal to the weighting factor applied to messages in bins representing less recent time intervals (or vice-versa). For example, a first bin (which may represent a most recent time interval) may have a weighting factor of 1.0, a second bin may have a weighting factor of 0.8, a third bin may have a weighting factor of 0.8, a fourth bin may have a weighting factor of 0.5, and a fifth bin may have a weighting factor of 0.1. In this example, wherein the weighting factor applied to messages in bins representing more recent time intervals is greater than or equal to the weighting factor applied to messages in bins representing less recent time intervals, the fourth bin could not have a weighting factor of 0.9 since that would be greater than the weighting factor of the third bin. Of course, in some embodiments the weighting applied to messages may not be ordered/independent of the time (interval) at which a message was received.

In step 1410, in some embodiments, a determination is made as to whether the sum of the weighted amount of received messages in each bin less than a threshold. For example, if each of 5 bins originally included 5 received messages, and the first bin has a weighting factor of 1.0, the second bin has a weighting factor of 0.8, the third bin has a weighting factor of 0.8, the fourth bin has a weighting factor of 0.5, and the fifth bin may have a weighting factor of 0.1, then the sum of the weighted amount of received messages in each bin would be 16 (e.g., ((5×1.0)+(5×0.8)+(5×0.8)+(5×0.5)+(5×0.1), or (5+4+4+2.5+0.5)).

In step 1412, in some embodiments, process 1400 causes an action to occur in response to the sum of the weighted amount of received messages in each bin being below a threshold. For example, if the sum is 16, and the threshold is 20, then an action will occur. An action may be adverse, and may include disabling a vehicle's authority to use full braking, dissolving a platoon, and/or deauthorizing a vehicle from platooning.

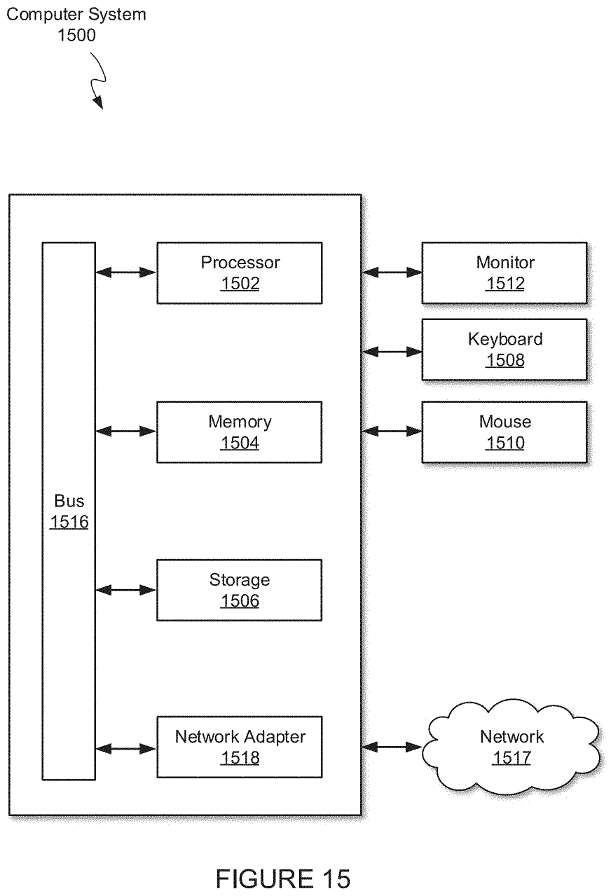

FIG. 15 illustrates an example computing system, in accordance with some embodiments.

In various embodiments, the calculations performed above may be discussed in the general context of computer-executable instructions residing on some form of computer-readable storage medium, such as program modules, executed by one or more computers or other devices. By way of example, and not limitation, computer-readable storage media may comprise non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

This disclosure contains numerous references to a NOC and to one or more processors. According to various aspects, each of these items may include various kinds of memory, including non-volatile memory, to store one or more programs containing instructions for performing various aspects disclosed herein.

For example, as shown in FIG. 15, example computing system 1500 may include one or more computer processor(s) 1502, associated memory 1504 (e.g., random access memory (RAM), cache memory, flash memory, read only memory (ROM), electrically erasable programmable ROM (EEPROM), or any other medium that can be used to store the desired information and that can be accessed to retrieve that information, etc.), one or more storage device(s) 1506 (e.g., a hard disk, a magnetic storage medium, an optical drive such as a compact disk (CD) drive or digital versatile disk (DVD) drive, a flash memory stick, etc.), and numerous other elements and functionalities. The computer processor(s) 1502 may be an integrated circuit for processing instructions. For example, the computer processor(s) may be one or more cores or micro-cores of a processor. The computing system 1500 may also include one or more input device(s) 1510, such as a touchscreen, keyboard, mouse, microphone, touchpad, electronic pen, or any other type of input device. Further, the computing system 1500 may include one or more output device(s) 1508, such as a screen (e.g., a liquid crystal display (LCD), a plasma display, touchscreen, cathode ray tube (CRT) monitor, projector, or other display device), a printer, external storage, or any other output device. The computing system 1500 may be connected to a network 1514 (e.g., a local area network (LAN), a wide area network (WAN) such as the Internet, mobile network, or any other type of network) via a network interface connection 1518. The input and output device(s) may be locally or remotely connected (e.g., via the network 1512) to the computer processor(s) 1502, memory 1504, and storage device(s) 1506.

One or more elements of the aforementioned computing system 1500 may be located at a remote location and connected to the other elements over a network 1514. Further, embodiments of the invention may be implemented on a distributed system having a plurality of nodes, where each portion of the invention may be located on a subset of nodes within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

For example, one or more of the software modules disclosed herein may be implemented in a cloud computing environment. Cloud computing environments may provide various services and applications via the Internet (e.g., the NOC). These cloud-based services (e.g., software as a service, platform as a service, infrastructure as a service, etc.) may be accessible through a Web browser or other remote interface.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared, and other wireless media. Combinations of any of the above can also be included within the scope of computer-readable media.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment.

While this disclosure has been described in terms of several aspects, there are alterations, modifications, permutations, and equivalents which fall within the scope of this disclosure. In view of the many alternative ways of implementing the methods and apparatuses of the present disclosure, it is intended that the following appended claims be interpreted to include all such alterations, modifications, permutations, and substitute equivalents as falling within the true scope of the present disclosure.

What is claimed is:

1. A method for determining whether to cause an action, the method comprising:
determining an amount of received messages received during at least one time interval;
causing an action in response to the amount of received messages received during each of the at least one time intervals being below a threshold amount of received messages; and
refraining from causing an action in response to the amount of received messages received in the at least one time interval being above the threshold amount of received messages.

2. The method of claim 1, further comprising:
determining a rate of received messages; and
wherein causing an action further comprises the rate being less than a threshold rate in addition to the amount of received messages being received during each of the at least one time intervals being below a threshold amount of received messages, and wherein refraining from causing an action further comprises the rate being greater than a threshold rate instead of or in addition to the amount of received messages received in the at least one time interval being above a threshold amount of received messages.

3. The method of claim 1, wherein the action is an adverse action, and wherein the messages indicate that at least one Anti-Lock Braking System (ABS) is operating correctly.

4. The method of claim 1, wherein the action is allowing full brakes or authorizing platooning.

5. The method of claim 3, wherein the adverse action is causing a platoon of vehicles to dissolve.

6. The method of claim 2, wherein the rate of received messages is an amount of messages received over a number of time intervals divided by a length of a time interval, multiplied by the number of time intervals.

7. The method of claim 2, wherein the rate of received messages is a rate of received MID11 messages, and the amount of received messages received a time interval is an amount of MID11 messages received the time interval.

8. The method of claim 1, wherein the at least one time interval is a current one-second interval, the current one-second interval and a previous one-second interval, or the current one-second interval and two previous one-second time intervals.

9. The method of claim 2, wherein the threshold amount of received messages is the same as the threshold rate.

10. The method of claim 9, wherein the received messages are MID11 messages received via a Power Line Communication (PLC).

11. The method of claim 1, wherein refraining from causing an action confirms that a driver selected a correct tractor trailer configuration.

12. The method of claim 11, wherein the confirmation is transmitted to a Network Operations Center (NOC) or a remote terminal.

13. A method for determining whether to cause an action, comprising:
determining an amount of received messages in at least two bins, wherein each bin represents a time interval;
applying a weighting factor to the amount of received messages in each bin;
determining a sum of the weighted amount of received messages in each bin;
determining whether the sum is less than a threshold; and
causing an action to occur in response to the sum being less than the threshold.

14. The method of claim 13, wherein the weighting factor applied to messages in bins representing more recent time intervals is greater than or equal to the weighting factor applied to messages in bins representing less recent time intervals.

15. The method of claim 13, wherein the received messages are MID11 messages sent from at least one Anti-Lock Braking System (ABS) unit to a brake electronic control unit (BECU) via a Power Line Communication (PLC), and wherein the action includes disabling full braking authority of one or more tractor trailers, enabling full braking authority of one or more tractor trailers, or dissolving a platoon.

16. A method for determining whether to perform an action, comprising:
receiving an identifier from one or more trailers or one or more dollies connected to a tractor, wherein the identifier is received in response to a request; and
perform the action in response to the received identifier.

17. The method of claim 16, wherein the identifier is determined based on the receipt of a message including a unique identifier, wherein the unique identifier corresponds to a trailer or a dolly.

18. The method of claim 16, wherein the identifier is determined based on the receipt of a unique message, wherein the unique message corresponds to a trailer or a dolly.

19. The method of claim 16, wherein the request is for a message to be sent from an Anti-Lock Braking System (ABS) unit to a brake electronic control unit (BECU) via a Power Line Communication (PLC), wherein the action includes disabling full braking on a tractor trailer combination including the one or more trailers and one or more dollies, enabling full braking on a tractor trailer combination including the one or more trailers and one or more dollies, and dissolving a platoon of two or more tractor trailer combinations, wherein one of the two or more tractor trailer combinations includes the tractor trailer combination including the one or more trailers and one or more dollies.

20. A method for determining whether to cause an action, the method comprising:
determining an amount of received messages received during at least one time interval;
causing an action in response to the amount of received messages received during each of the at least one time intervals being above a threshold amount of received messages; and
refraining from causing an action in response to the amount of received messages received in the at least one time interval being below the threshold amount of received messages.
